(19) United States
(12) Patent Application Publication
(10) Pub. No.: US 2013/0219422 A1
(43) Pub. Date: Aug. 22, 2013

(54) SYSTEM AND METHOD FOR PROVIDING INTERNET PROTOCOL VIDEO INTEGRATION WITHIN A HOME VIEWING NETWORK

(71) Applicant: Sushil Kambampati, Wichita, KS (US)

(72) Inventor: Sushil Kambampati, Wichita, KS (US)

(21) Appl. No.: 13/768,128

(22) Filed: Feb. 15, 2013

Related U.S. Application Data
(60) Provisional application No. 61/601,072, filed on Feb. 21, 2012.

(51) Int. Cl. H04N 21/482; H04N 21/258

(52) U.S. Cl. CPC H04N 21/482; H04N 21/25866
USPC 725/25; 725/48

(57) ABSTRACT

An improved audiovisual device enables users to watch content delivered over a network with the same ease of operation as a television set. The device is configured to accept an input stream from an IP network connection. Audiovisual content is delivered to the device in a home environment which improves upon current delivery methods by providing the simplicity of broadcast/cable television viewing while delivering content over an IP network connection. Users are enabled to access and view video and other multimedia content in the audiovisual device by means of stored bookmarks. The audiovisual device may be configured to treat all incoming video streams as channels that are accessible to a user in a same manner as television channels. The device may be configured to display incoming signals either in a full screen format or in a format including a plurality of independent screen segments on the display.

### RELATED APPLICATIONS

This patent application claims priority to U.S. Provisional Patent Application No. 61/601,072, filed Feb. 21, 2012. The entire contents of this provisional application are hereby incorporated by reference.

### BACKGROUND

1. Field of the Invention

The present invention relates generally to techniques for delivering audiovisual content to an audiovisual device in a home environment, and more particularly to a system and method that provides Internet Protocol (IP) video integration within a home environment with the same ease of operation as broadcast or cable television.

2. Description of the Related Art

The nature of television programming delivery to consumers is changing faster than ever before. In the most recent decade, consumers have demanded control of the choice of when and where to watch content, instead of having it dictated to them by providers and distributors. With time and place “shifting”, a consumer is no longer restricted to watching a TV program at a proscribed hour or a movie at preselected times and locations. In addition to controlling the choice of time and location, consumers have an ever expanding variety of content sources to choose from, such as production-house content available on television, video on demand or Digital Versatile Disk (DVD), amateur content available on video hosting sites such as YouTube and Vimeo, and self- or custom-recorded content from video recorders, Webcams and smartphones. Extensive rapid expansion of broadband access into the consumer market has provided home, domestic and small office users an opportunity to make radical changes to their usage. New ways to deliver video and television via IP offer more choice and higher quality.

In many markets, considerable amounts are spent on domestic consumer hardware and other technologies to meet the demands for broadband access into the home. Broadcast television requires a TV with a RF tuner and adequate reception. Cable TV and IPTV require set top boxes and constrict the viewer to the local provider. Other Internet video delivery methods require dedicated devices or specific software applications. A Media Server streams media to a multitude of networked devices in the home or away, overcoming the devices inherent limitations by performing all of the necessary conversions in real time, and thus making the media available anywhere, anytime and on any device.

### SUMMARY

It is an object of the present invention, therefore, to provide an improved audiovisual device that enables users to watch content delivered over a network with the same ease of operation as a television set.

It is another object of the present invention to provide an improved audiovisual device that is configured to accept an input stream from an IP network connection.

It is a further object of the present invention to provide a method for delivering audiovisual content to an audiovisual device in a home environment, which improves upon current delivery methods by providing the simplicity of broadcast/cable television viewing while delivering content over an IP network connection.

It is a still further object of the present invention to enable users to access and view video and other multimedia content in an audiovisual device by means of stored bookmarks.

In accordance with the above-described objects and those that will be mentioned and will become apparent below, an audiovisual device, according to an embodiment of the present invention, comprises an input, the input being configured to accept an IP connection, where the IP connection receives content from remote network servers identified by a user; an output, the output being configured to output the content supplied from the remote network server on a video display of the audiovisual device; system control software, a Web browser, a memory, a disk storage, and a video display.

In one aspect, an apparatus is provided, comprising a processor, a memory having stored therein computer executable instructions, that when executed by the processor, cause the apparatus to provide a user with an option of selecting audio-visual content from both an ad-hoc source and a pre-defined source, receive from the user, a first election to receive audio-visual content from said ad hoc source, and in response to receiving said first election, receive from the user, a URL associated with audio-visual content identified by the user, send, by the apparatus, a request to a remote server identified by the URL, display a server response to the request on the apparatus, receive from the user, a second election to receive audio-visual content from said pre-defined source, and in response to receiving said second election, display a plurality of bookmark positions to a user on a display of the apparatus, wherein each bookmark position is associated with a URL identifying a remote server storing audio-visual content, receive a user selection of a bookmark position from the plurality of bookmark positions displayed by the audio-visual device, send a request to a remote server identified by the URL associated with the selected bookmark position, display a server response to the request at the audio-visual device sent from the remote server, receive the audio-visual content at the audio-visual device from the remote server.

In one aspect, a method is provided for delivering audio-visual content to an audio-visual device in a home environment from one or more ad hoc sources of audio-visual content and/or one or more pre-defined sources of audio-visual content, the method comprising: providing the user with the option to select audio-visual content from both an ad-hoc source and a pre-defined source, electing by the user to receive to audio-visual content from an ad hoc source, comprising: receiving from the user, a URL-entry mode of the audio-visual device, receiving from the user, a URL associated with audio-visual content identified by the user, sending, from the device , a request to a remote server identified by the URL associated with the audio-visual content identified, displaying, on the device, a server response to the request at the audio-visual device sent from the remote server, electing by the user to receive audio-visual content from a pre-defined source, comprising: displaying a plurality of bookmark positions to a user on a display of the audio-visual device, wherein each bookmark position is associated with a URL identifying a remote server storing audio-visual content, receiving a user selection of a bookmark position from the plurality of bookmark positions displayed by the audio-visual device, sending from the device a request to a remote server identified by the URL associated with the selected bookmark position, displaying on the device a server response to the request at the audio-visual device sent from the remote server, receiving the audio-visual content at the audio-visual device from the remote server.

The audiovisual device may be configured to treat all incoming video streams as channels that are accessible to a user in a same manner as television channels. The device may be configured to display incoming signals either in a full screen format or in a format including a plurality of independent screen segments on the display.

In one embodiment, an audiovisual device is configured to be able to connect to a network and store Uniform Resource Locators (URLs) as bookmarks in the audiovisual device. Each bookmarked URL is assigned a unique integer value that corresponds to a channel within a set of channels to be associated with multimedia content, especially but not limited to IP video content, sourced from the bookmarked URLs.

In one embodiment, a method is disclosed for assigning bookmarked URLs to channel IDs in an audiovisual device in a home environment. Each URL corresponds to a source of multimedia content. The method is described further below with respect to FIG. 3.

In one embodiment, a method is disclosed for simultaneously assigning a plurality of bookmarked URLs to channel IDs in an audiovisual device in a home environment. The method is described further below with respect to FIG. 3.

As will become apparent, advantages of the invention include, but are not limited to, providing a system and method for delivering audiovisual content sourced via a network such as the Internet to an audiovisual device in a home environment which improves upon current delivery methods by applying the simplicity of broadcast/cable television viewing.

In one aspect, a remote server, having an associated URL, may require authentication in order to provide access to the IP video content stored there. The authentication may be according to a defined protocol, such as, for example, HTTP Basic Access Authentication (as defined by the Internet Engineering Task Force's RFC 1945 and RFC 2617), or by responding with a Web page containing a username and password fields. The remote server may alternatively, or in addition, set an HTTP cookie that keeps the user logged in or authenticated in future visits.

In one aspect, a content streaming service that wishes to charge customers for viewing content may require a user to authenticate himself or herself via a username and password in accordance with known Internet standards for exchanging credentials, such as, for example, HTTP Basic Authentication methods.

In addition, the audiovisual device may provide the viewer the option of storing the username and password required for the server associated with a URL, to be recalled and provided on behalf of the user on subsequent visits to the remote server at that URL.

### BRIEF DESCRIPTION OF THE DRAWINGS

These and other objects, features and advantages of the present invention will be apparent from a consideration of the following Detailed Description of the invention, when considered in conjunction with the drawing Figures, in which:

FIG. 1 is a block diagram of an example network architecture for devices, machines, services, systems and instructions to interact and perform any one or more of the methodologies discussed herein, according to an example embodiment of the disclosure.

FIG. 2 is a diagram of an example audio-visual device within which a set of instructions for causing the machine to perform any one or more of the methodologies discussed herein may be executed, according to an example embodiment of the disclosure.

FIG. 3 is a diagram showing a process for adding bookmarked URLs at an audiovisual device, such as the one shown in FIG. 2, where each bookmarked URL corresponds to an IP video source to be represented as a single channel within a set of channels to be displayed to a viewer at the audiovisual device, according to one embodiment.

FIG. 4a is a diagram showing a process for consuming content from an ad-hoc source that has not been previously saved in the system.

FIG. 4b is a diagram showing a process for consuming content from a source that has previously been saved in the system.

FIG. 5 is a diagram showing a process authenticating the user when a remote server requires it.

FIG. 6a is an example of the system operating in content consumption mode and the user has pressed the URL key to enter a URL that is not in the system. This corresponds to the process depicted in FIG. 4a.

FIG. 6b is an exemplary illustration of what a user is shown when the system is operating in content consumption mode and the user is selecting a bookmark (channel) to be displayed. This corresponds to the process depicted in FIG. 4b.

FIG. 7 is a diagram of a remote control device for use with the audio-visual device of the invention, according to one embodiment.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention and are considered to be within the understanding of persons of ordinary skill in the relevant art.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As will be demonstrated herein and below, the invention permits, among other things, the ability to associate a channel number on an audiovisual device to a remote audio or video stream received over a network, such as the Internet. In this manner, Internet Protocol (IP) audiovisual content integration is provided within a home listening or viewing environment with the same ease of operation as broadcast or cable television.

In particular, for ease of illustration, invention embodiments are primarily discussed in the context of a residential setting. The invention is not limited to use in a residential setting. The invention could be used in any setting where a network connection is present, such as an office or other business location.

The disclosed invention is a technology for delivering IP multimedia content to a home environment that enables viewers to consume IP content delivered over a network such as the Internet with the same ease of operation as watching conventional broadcast or cable television, without the need for additional dedicated hardware devices, such as set top boxes, or additional software applications.

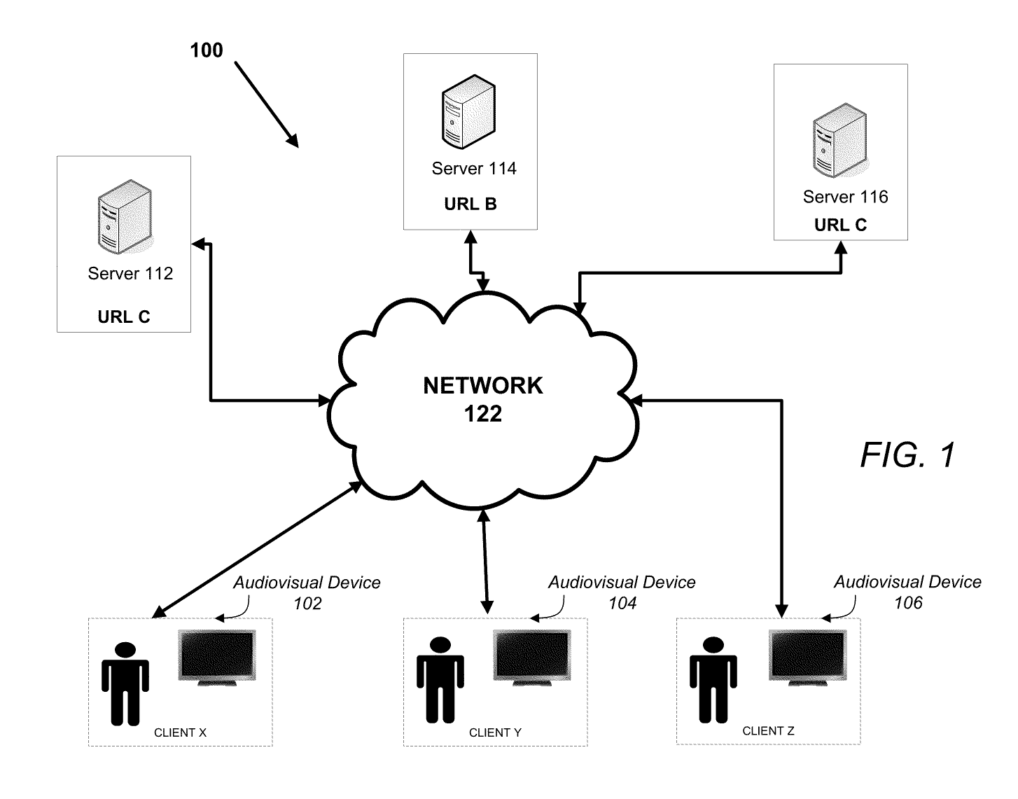

FIG. 1 is now presented for purposes of providing an example network architecture and machine architecture for which devices can interact to achieve the teachings and techniques presented herein. This layout and configuration is presented for purposes of illustration only and is not intended to limit the embodiments presented herein.

FIG. 1 is a diagram of an example network architecture for devices, machines, services, systems and instructions to interact and perform any one or more of the methodologies discussed herein, according to an example embodiment of the disclosure.

FIG. 1 may also be viewed as an example audiovisual content distribution system 100 that is implemented in accordance with at least one embodiment of the present disclosure. As shown, the system 100 includes a plurality of multimedia content sources, such as servers 112, 114, 116, and audiovisual devices 102, 104, 106.

In the illustrated embodiment, the plurality of multimedia content sources 112, 114, 116 are connected via a network 122, where the network can include, without limitation, the Internet, a cable television distribution network, a satellite distribution network, a broadcast television distribution network, a data packet-based computer network, and the like. Likewise, a plurality of audiovisual devices 102, 104, 106 are connected to the plurality of multimedia content sources 112, 114, 116 via the network 122.

According to one embodiment of the present invention, the audiovisual devices, upon initial activation, will come factory-configured with any known multimedia content services (e.g., multimedia content servers) at the time of manufacturing. Thereafter, users can add additional multimedia content services by either bookmarking a URL associated with a particular multimedia content source, or otherwise by entering a URL referring to a seeding service which responds by sending a multiplicity of audiovisual URL resources, which are then stored as bookmarks in the audiovisual device. Each bookmark is associated with a particular URL and is assigned a unique numerical identifier, analogous to a channel number, which can be retrieved by a user by scrolling through a list of stored bookmarks. The user can also assign the unique ID via a remote control. In one embodiment, the user can set a base position for a first URL in a set of URLs to be returned via the seeding service. The returned URLs would then be assigned IDs associated with the base position and for positions occupying unique integer increments from the base position. For example, if a seeding service returns 20 different URLs, the user has the option of setting the first URL to be associated with unique ID 101. The remaining 19 URLs would then be associated with bookmark positions 102, 103, 104, . . . , to 120.

As will be demonstrated herein and below, the processing of Internet Protocol (IP) audio or video content permits among other things, the ability to associate a channel number associated with an audiovisual device to a remotely distributed IP content stream.

In one embodiment, the response from a seeding server may include an additional URL from which the audiovisual device may retrieve Electronic Program Guide (EPG) information. This information may be presented to the viewer in a portion of the screen when the associated channel is being viewed, or it may be aggregated with EPG information from all the other sources known to the audiovisual device and displayed that way. Without specifying the information exchange protocol that would be used to convey the EPG data, the data could contain, for any particular program, start time including time-zone, duration, program name, description, any content ratings or advisories that the content provider chooses to include, and an image to represent the program.

The application of the present invention is not limited to any particular type of multimedia “content”. Exemplary types of content received over an IP connection includes, for example, audio from Internet radio stations, images in a slideshow stream from a photo storage site such as Flickr.com or Webshots.com, or videos from sites such as Xfinity.com, ESPN3.com, YouTube or Vimeo. Other content sources well known to those familiar with the art are within contemplation of the invention.

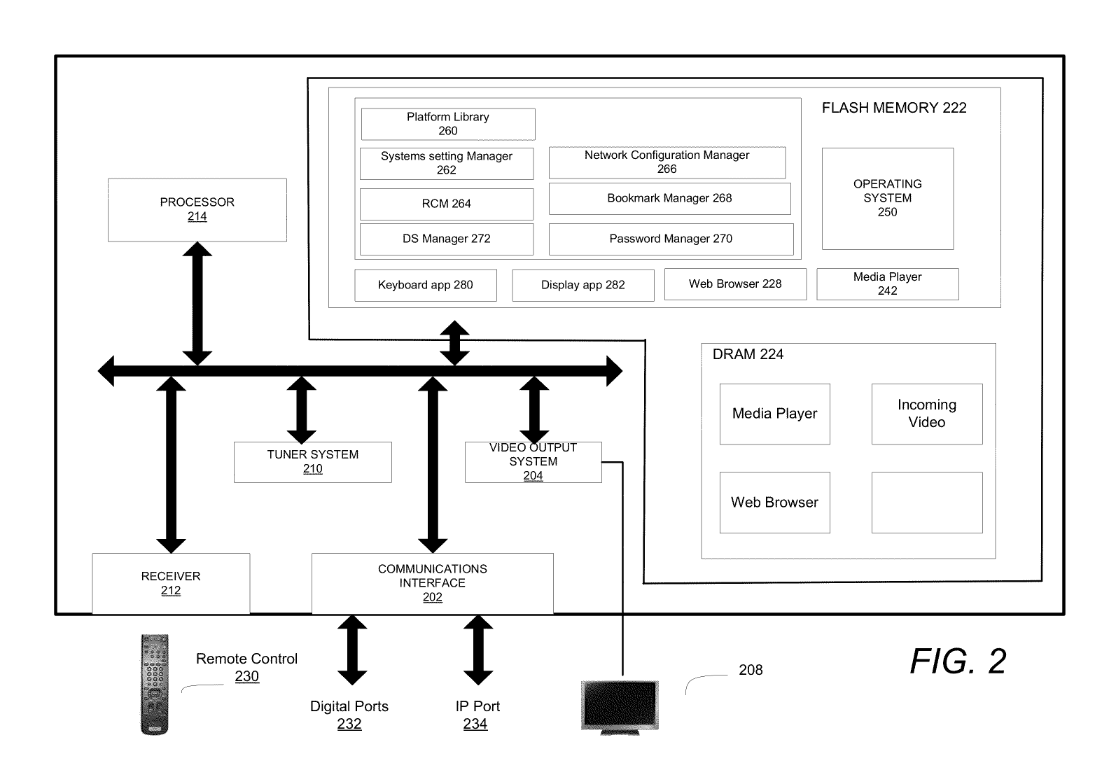

FIG. 2 is a diagram of an example device 200 within which a set of instructions for causing the machine to perform any one or more of the methodologies discussed herein may be executed, according to an example embodiment of the disclosure. The device 200 is typically situated within a residence or business of a user. It may be integrated into a display unit, similar to a television set, or it may otherwise be a stand-alone unit that couples to an external display, such as a display included with a computer or a television. The display device also includes audio output equipment.

The device 200 preferably further comprises a communication interface 202 for receiving an IP signal from an IP connection 234. Incoming data can include media such as video, audio, graphical and text information. The device 200 further includes at least one processor 214 for controlling operations of the device 200 including a video output port such as an HDMI output system 204 for driving the display 208.

Additionally, the device 200 may further optionally include a RF tuner system 210 for tuning into a particular RF signal (such as broadcast television) to be displayed. The device 200 may also include a RF receiver 212 for receiving externally generated information, such as user inputs or commands (such as a remote control). The user inputs may, for example, be provided by a computer or transmitter with buttons or keys located either on the exterior of the terminal or by a hand-held remote control device 230 or keyboard that includes user-actuated buttons.

The device 200 may also optionally include one or more wireless or wired interfaces, also called ports 232, for receiving and/or transmitting data to other devices. For instance, the device 200 may feature USB (Universal Serial Bus), Ethernet (for connection to a computer), IEEE-1394 (for connection to media devices in an entertainment center), serial, and /or parallel ports.

In one implementation, a memory portion of the device 200 includes flash memory 222 and dynamic access memory (DRAM) 224 for storing the executable programs and related data components of various application and modules for execution by the device 200. Both the flash memory 222 and the DRAM memory 224 are coupled to the processor 214 for storing configuration data and operational parameters, such as commands that are recognized by the processor 214.

The basic functionality of the device 200 is provided by an operating system (OS) 250 that is contained in flash memory 222. In one embodiment, it is contemplated to use a commercially licensable open source product operating system (OS), such as Linux or Android. One or more software programs, herein referred to as applications, are executed by utilizing the computing resources in the device 200. The application stored in flash memory 222 or DRAM 224 is executed by processor 214 (e.g., a central processing unit) under the control of the operating system 250. Data manipulated by the application is stored in DRAM 224 as need be during the course of program execution. Input data may be data stored in DRAM 224 by a secondary application or other source, either internal or external to the device 200. Data may be received via any of the communication ports of the device 200, from the digital signal ports 232 or IP port 234 or as user input via receiver 212. A type of input data fulfills and serves the purpose of parameters as described below. Data generated by application program is stored in DRAM 224 by processor 214 during the course of application program execution. The flash memory also contains a platform library 260. The platform library 260 is a collection of functionality useful to applications, such as a Systems Settings Manager 262, a Remote Control Manager (RCM) 264, a Network Configuration Manager 266, a Display Settings Manager 272 and a Bookmark Manager 268 and other utilities (not shown). These utilities are accessed by applications so that each application does not have to contain these utilities thus resulting in memory consumption savings and a consistent user interface.

In another embodiment the OS may be proprietary and custom created for the purposes of the device.

The System Settings Manager 262 allows the user to navigate amongst various system settings, such as the network configuration, bookmark management, display settings, and additional application plugins.

The remote control manager (RCM) 264 listens for input from the remote control and sends commands to the OS 250 or the application currently using the display (e.g., the display application).

The Network Configuration Manager 266 allows the user to set up the home networking access including WiFi network selection and DNS.

The Bookmark Manager (BM) 268 lists the existing URLs and their positions, thus allowing the user to manage the bookmarks (edit, delete, or change positions). When the user selects to enter a new URL, the bookmark manager (BM) 268 will query the user to select whether the URL targets the content itself or whether it targets a seeding server that will provide the content URLs.

In an alternate embodiment, the bookmark manager (BM) 268 uses programmatic logic to determine what type of URL was entered based on the response from the server. The bookmark manager (BM) 268 will also test the URL to confirm whether the remote server is responding. In this scenario, the bookmark manager will analyze the response to determine whether a username and password are required, and if so, will request both. The bookmark manager (BM) 268 will also allow the user to enter a URL destination without saving it in the bookmarks list, i.e., a temporary URL. In an embodiment, the bookmark manager (BM) 268 may also maintain a history of URLs visited.

A password manager 270 keeps track of usernames and passwords associated with URLs.

A display settings manager 272 allows a user to manage standard display settings such as brightness, contrast, etc.

A keyboard application 280 and a display application 282 are all resident applications in flash memory 224. The keyboard application 280 listens for input from buttons on the console and sends commands to the OS or to an application currently using the display. These applications, because they are in flash memory 222, are always available to the user and do not need to be downloaded each time the device 200 initializes. The applications are contemplated to be commercially licensable applications, which may be open source products. In an embodiment, although not shown, a console of the device 200 may contain fewer buttons than the remote control 230, choosing to omit the number pad, for example.

The applications that are stored in the DRAM 224 may be applications that are loaded when the device 200 initializes. In this non-limiting example, as shown in FIG. 2, DRAM 224 contains the following application clients: Web browser 228, and Media Player 242. It should be clear that these applications are not limiting and merely serve as examples for this present embodiment of the invention.

The Web browser application 228 is used to render and display an HTML page that results from the selection of a stored bookmark or temporary URL.

The Media Player application 230 can play audio and video content in many common formats, not limited to, but including, for example, Quicktime, AVI, MPEG-4, and MP3. The Media Player application 230 can be extended to handle new formats via software updates or downloadable plug-ins.

Remote Control 230

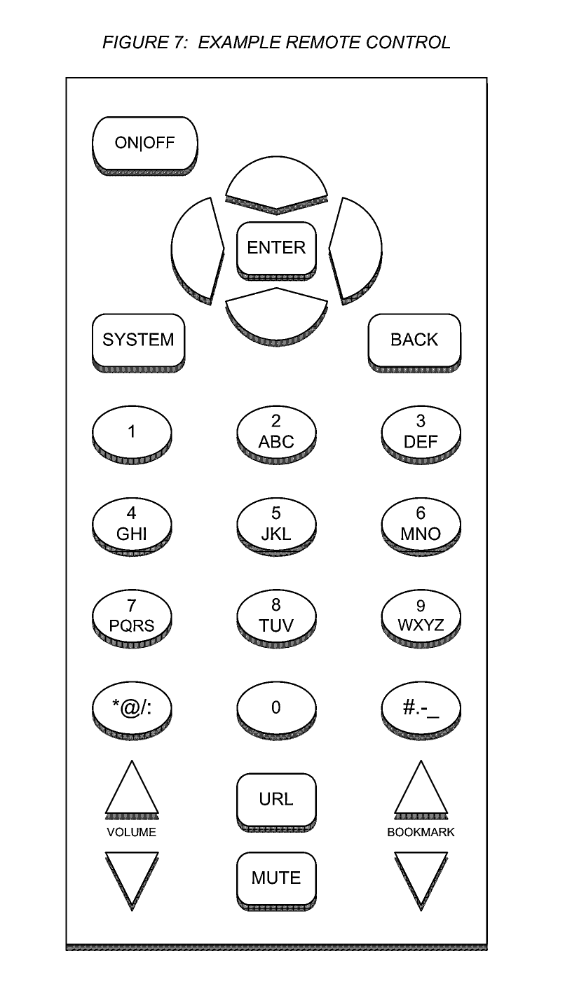

As shown in FIG. 7, and also as element 230 in FIG. 2, a remote control includes a number of buttons including: a Power button: for toggling between on and standby. Holding this button time for more than a few seconds turns device 200 off. Volume buttons: Up/Down/Mute. Position buttons: Up/Down. A System button: for loading the system manager. A Back button: (contextual) generally takes the user back one level. An Enter button (contextual) generally indicates that a user has finished entering data. Directional Buttons—(contextual) generally left, right, up, down. Number buttons—organized in telephone style format. Symbol buttons—including telephone keypad # and *. A URL button—indicates to device 200 that a user wishes to type in a URL.

Operation

The general modes of operation, according to one embodiment, include, initial power on, system set-up mode, content consumption mode. Each mode is explained in detail below.

Initial Power On

At initial power on, a boot loader does an initial hardware check and performs various other boot-up tasks. Thereafter, the operating system (OS) 250 is loaded. See FIG. 2. The OS 250 goes through a number of initialization routines and then loads the media player 242 which looks up the last URL that was accessed and loads content from the URL location into media player 242.

System Set-up Mode

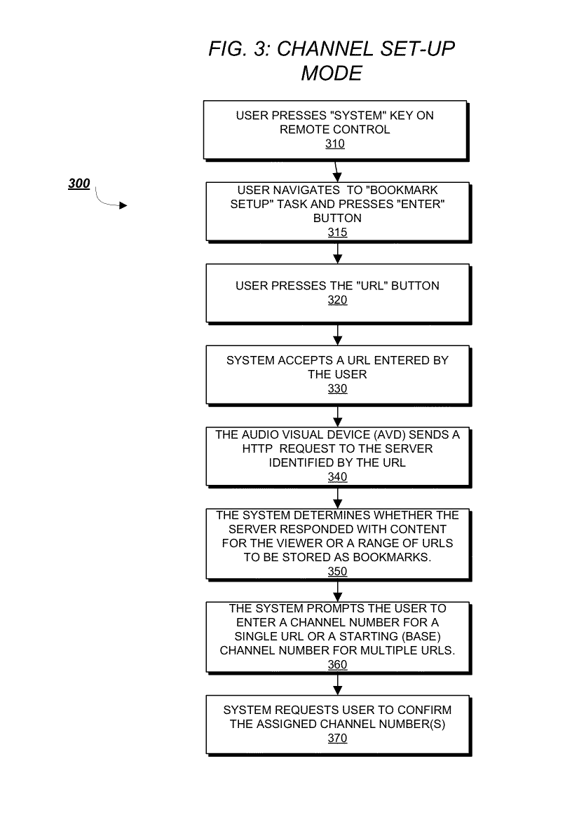

With reference now to FIG. 3, there is shown an exemplary process 300 for entering and performing actions associated with a “System Setup” mode of the invention.

In the system set-up mode, the “Back”, “Enter”, and directional buttons will have meaning, as well as the number symbol buttons. During the system set-up mode if the system expects alphanumeric data from the user (such as a URL, username or password) then the number buttons have overloaded values and can be used to enter letters as well as numbers.

At act 310, a user presses the “SYSTEM” key on Remote Control 230, as shown in FIG. 7 and navigates a menu of tasks to highlight “Bookmark Setup”.

At act 315 the user presses the “ENTER” button on Remote Control 230.

At act 320, the user presses the “URL” button on Remote Control 230.

At act 330, the audiovisual device accepts a single URL, which may be a direct link to audiovisual content, or otherwise it may be a URL for a seeding service. A content URL could be a link to, for example, a YouTube video or a Website such as ibm.com, and in response to a request the remote servers would send user-consumable content. If the content URL points to a general Web site or to a source of audio/visual content, the audiovisual device will load and display the resulting page or media for the user to confirm that this is indeed what they expected.

Entering a URL for a seeding service results in a different response from the remote server. Typically, the response from a seeding service would return metadata for some audio or video content, including but not limited to, for example, Internet radio. The metadata response may include information such as the name of the content source (“Classic Rock”), a description of the content itself (“Rock and roll music from the '60s and '70s”), whether a password is required and the URL to the content stream. The response may also include a URL from which the device could retrieve electronic program guide (EPG) information. The response could contain a single content URL (i.e., “channel”) or a multiple content URLs (i.e., “a block of channels”).

At act 340, the system makes a request to the remote server identified by the URL that the user entered previously. In one embodiment, the request is an HTTP request. In other embodiments the request can be an HTTPS, FTP or REST type request.

At act 350, the system receives and analyzes the response from the remote server to determine whether the response contained either user content, seeding metadata for a single content stream or metadata for multiple streams

At act 360, if the response was for one content stream, then the audiovisual device prompts the user to enter a channel number for a single URL. If the response contained multiple content URLs then the user is prompted for a starting (base) channel number and the other URLs are assigned numbers in integer increments from the base.

At act 370, the user confirms the assigned channel number.

Content Consumption Mode

Content Consumption mode is sometimes referred to herein as “IP video integration service”.

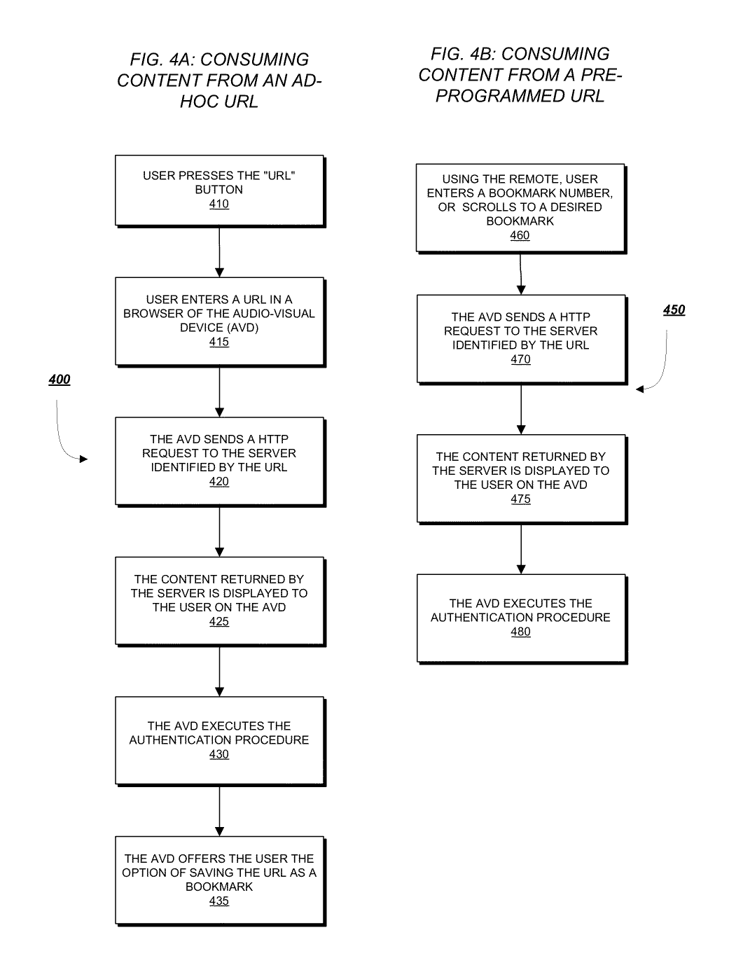

With reference now to FIGS. 4a and 4b, there are shown exemplary processes 400 and 450 for viewing Internet Protocol (IP) video content within a home environment, according to an example embodiment of the invention. The processes connect the system to either an ad-hoc URL entered by the user or to a previously stored URL selected by the user, and then retrieve the content from the remote source for display.

The instructions may be implemented on a removable medium and subsequently interfaced to an audiovisual device that embodies the present invention, wherein the instructions are uploaded within the device and processed. Alternatively, the instructions may be prefabricated within memory or storage of an embodiment and loaded for execution when the device is initiated or booted. In still another arrangement, the instructions may be downloaded from a network storage location or other network machine to a target embodiment on the network and processed. In yet another situation, the instructions may be remotely processed over a network on one device on behalf of a different network device embodying the current invention.

Content Consumption Mode from an Ad-Hoc Source

The process described in FIG. 4a illustrates a method for consuming content from an ad-hoc source that has not previously been saved in the system.

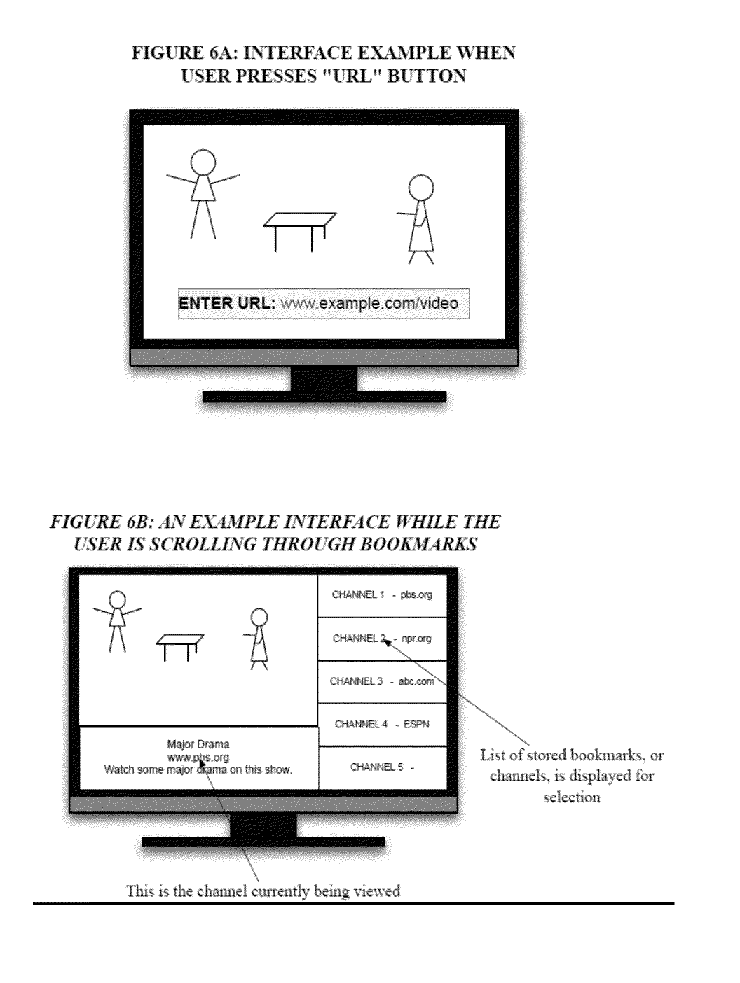

Initially, at act 410, a user presses the “URL” button on the console in order to switch the system into URL-entry mode, as shown in FIG. 6a.

At act 415, a user enters, by means of a remote control device or other data-entry device (such as a Bluetooth keyboard), a URL associated with IP content of interest to the user. The user presses the “ENTER” button once the URL has been completely entered. By pressing the “ENTER” button the device is allowed to connect to the URL specified by the user.

At act 420, the system sends a request to the server at the specified URL. In one embodiment, the request is an HTTP request. In other embodiments the request can be an HTTPS, FTP or REST type request.

At act 425, the system displays the content sent back by the server.

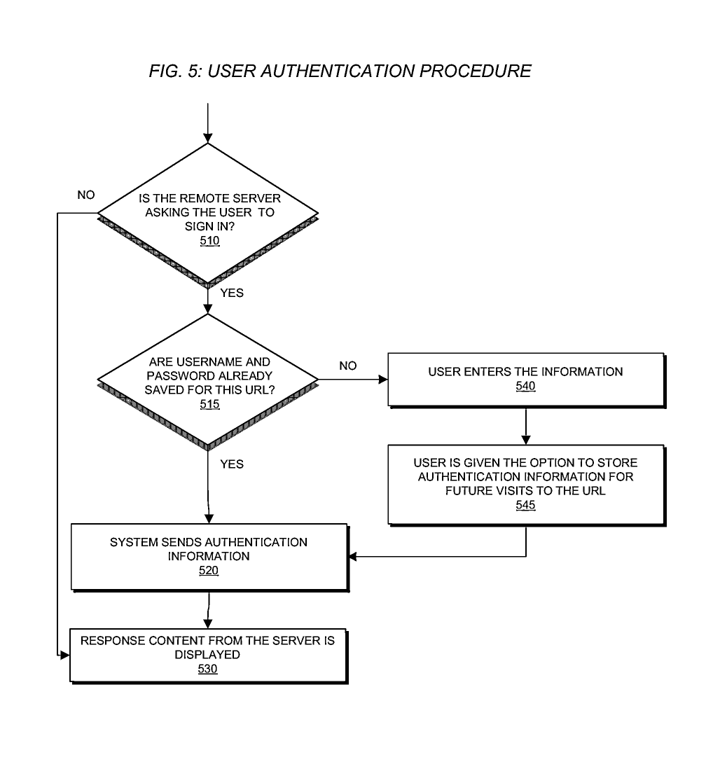

At act 430, the system evaluates the response from the server to determine whether the user must sign-on in order to consume the content. The authentication procedure is described below and depicted in FIG. 5.

At act 435, the user is offered the option to store this URL as a bookmark for future use. Without repeating the steps here, they are the same as 350-370 described above.

Content Consumption Mode from a Previously Programmed Source

With reference now to FIG. 4b, there is shown another exemplary process 450 for integrating Internet Protocol (IP) audiovisual content within a home environment, according to an example embodiment of the disclosure. In this process, the content source has previously been saved as a bookmark in the system.

Initially, at act 460, a user enters a bookmark position by using the numeric buttons, or scrolls through the stored bookmarks and selects a desired bookmarked URL. Referring to FIG. 6b, a user is shown a list of bookmarks (i.e., channels). By way of example, a user is currently watching a public television channel while a list of other bookmarks is shown to the side. FIG. 6b illustrates how the user may also be shown program meta-data associated with the bookmark (channel). In the present example, the user is shown meta-data for a dramatic show on the public television channel.

At act 470, the system sends a request to the remote server identified by the URL. In one embodiment, the request is an HTTP request. In other embodiments the request can be an HTTPS, FTP or REST type request.

At act 475 the system displays the response provided by the remote server.

At act 480, the system executes the authentication procedure, which may require the user to sign-in to the remote server.

User Authentication Procedure

When the user selects a bookmark and the system requests content from a remote server, the server may require the user to sign-in, either using HTTP Basic Authentication, a Web sign-in page or some other undisclosed method. FIG. 5 describes one process for authenticating a user with a remote server using a username and a password.

At Act 510 a basic determination is made whether or not the user is required to sign-in. If the system determines that authentication is not required, then the system displays the content from the remote server. If authentication is required then the system steps to Act 515.

At Act 515, a decision act, the system checks to see whether a username and a password have previously been saved for this URL. If the information is available then the process continues to Act 520, otherwise it continues to Act 540.

At Act 520 the system sends the authentication information to the remote server.

At Act 530 the response from the server is displayed to the user.

At Act 540 the user enters the authentication information, i.e., username and password, in response to being prompted by the system.

At Act 545 the user is given the option of having the system store the authentication information for future use so that they system might log in automatically. The process then continues to Act 520.

If the remote server does not use HTTP Basic Authentication but requires the user to authenticate via a Web login page, the system would not be able to make the determination at Act 510. In that case, the user would have to enter the username at every visit to the server if the server so requires. Some servers may set a HTTP cookie that would identify the user as an authenticated visitor, bypassing the need to log in at future visits. Furthermore, while the system may not be able to authenticate the user automatically, it could still store the username and password and fill the fields into the login form on future visits.

While the invention has been shown and described with respect to particular embodiments, it is not thus limited. Numerous modifications, changes and enhancements will now be apparent to the reader.

What is claimed is:

1. A method for delivering audio-visual content to an audio-visual device in a home environment from one or more ad hoc sources of audio-visual content and/or one or more pre-defined sources of audio-visual content, the method comprising:
a) providing the user with the option to select audio-visual content from both an ad-hoc source and a pre-defined source,
b) electing by the user to receive to audio-visual content from an ad hoc source, comprising:
i) receiving from the user, a URL-entry mode of the audio-visual device,
ii) receiving from the user, a URL associated with audio-visual content identified by the user,
iii) sending, from the device, a request to a remote server identified by the URL associated with the audio-visual content identified,
iv) displaying, on the device, a server response to the request at the audio-visual device sent from the remote server,
c) electing by the user to receive audio-visual content from a pre-defined source, comprising:
i) displaying a plurality of bookmark positions to a user on a display of the audio-visual device, wherein each bookmark position is associated with a URL identifying a remote server storing audio-visual content,
ii) receiving a user selection of a bookmark position from the plurality of bookmark positions displayed by the audio-visual device,
iii) sending from the device a request to a remote server identified by the URL associated with the selected bookmark position,
iv) displaying on the device a server response to the request at the audio-visual device sent from the remote server,
d) receiving the audio-visual content at the audio-visual device from the remote server.

2. The method according to claim 1, further comprising: executing an authentication procedure by the audio-visual device in the case where the server response to the request includes a requirement to execute an authentication procedure prior to accessing the audio-visual content to determine whether the user must sign-on to the server to enable downloading of the audio-visual content from the server identified by the URL.

3. The method according to claim 2, wherein the authentication procedure further comprises:
a) checking at the audio-visual device to determine whether authentication information has previously been saved for a URL,
b) determining whether authentication information has been previously saved for the URL
c) sending the authentication information from the audio-visual device to the server identified by the URL, where it is determined that authentication information has been previously saved for the URL,
d) displaying a response from the server identified by the URL to the user, where it is determined that authentication information has been previously saved for the URL,
d) otherwise entering authentication information by the user at the audio-visual device, where it is determined that authentication information has not been previously saved for the URL,
e) sending the authentication information from the audio-visual device to the server identified by the URL, where it is determined that authentication information has not been previously saved for the URL,
f) displaying a response from the server identified by the URL to the user, where it is determined that authentication information has not been previously saved for the URL.

4. The method according to claim 3, further comprising storing the authentication information in a memory associated with the audio-visual device.

5. The method according to claim 2, wherein the authentication procedure comprises: determining via a web page login whether the user must sign-on to the server to enable downloading of the audio-visual content from the server identified by the URL.

6. The method according to claim 1, further comprising storing the URL at the audio-visual device as a bookmark for future use in the case where the user has elected to receive to audio-visual content from an ad hoc source.

7. The method of claim 1, further comprising determining from the server response to the request whether the server response includes one of: user content, seeding metadata for a single content stream, seeding metadata for multiple content streams. In addition the seeding metadata may contain the URL where electronic program guide information may be retrieved.

8. The method according to claim 7, wherein if the server response includes seeding metadata for said single content stream, prompting the user to enter a channel number to be associated with the single content stream at the audio-visual device.

9. The method according to claim 7, wherein if the server response includes seeding metadata for multiple content streams:
prompting the user to enter a starting base channel number, and
associating the multiple content streams with the channel numbers starting with the user entered starting base channel number.

10. An apparatus, comprising a processor, a memory having stored therein computer executable instructions, that when executed by the processor, cause the apparatus to:
provide a user with an option of selecting audio-visual content from both an ad-hoc source and a pre-defined source,
A) receive from the user, a first election to receive audio-visual content from said ad hoc source, and in response to receiving said first election:
i. receive from the user, a URL associated with audio-visual content identified by the user,
ii. send, by the apparatus, a request to a remote server identified by the URL,
iii. displaying a server response to the request on the apparatus
B) receive from the user, a second election to receive audio-visual content from said pre-defined source, and in response to receiving said second election:
i. display a plurality of bookmark positions to a user on a display of the apparatus, wherein each bookmark position is associated with a URL identifying a remote server storing audio-visual content,
ii. receive a user selection of a bookmark position from the plurality of bookmark positions displayed by the audio-visual device,
iii. send an request to a remote server identified by the URL associated with the selected bookmark position,
iv. display a server response to the request at the audio-visual device sent from the remote server,
v. receive the audio-visual content at the audio-visual device from the remote server.

11. The apparatus according to claim 10, further comprising: executing an authentication procedure by the audio-visual device in the case where the server response to the request includes a requirement to execute an authentication procedure prior to accessing the audio-visual content to determine whether the user must sign-on to the server to enable downloading of the audio-visual content from the server identified by the URL.

12. The apparatus according to claim 11, wherein the authentication procedure further comprises the device:
g) checking to determine whether authentication information has previously been saved for a URL,
h) determining whether authentication information has been previously saved for the URL,
i) sending the authentication information from the device to the server identified by the URL, where it is determined that authentication information has been previously saved for the URL,
d) displaying on the device a response from the server identified by the URL to the user, where it is determined that authentication information has been previously saved for the URL,
j) otherwise entering authentication information by the user at the audio-visual device, where it is determined that authentication information has not been previously saved for the URL,
k) sending the authentication information from the device to the server identified by the URL, where it is determined that authentication information has not been previously saved for the URL,
l) displaying a response from the server identified by the URL on the device , where it is determined that authentication information has not been previously saved for the URL.

13. The apparatus according to claim 12, further comprising storing the authentication information in a memory associated with the audio-visual device.

14. The apparatus according to claim 11, wherein the authentication procedure comprises: determining via a web page login whether the user must sign-on to the server to enable downloading of the audio-visual content from the server identified by the URL.

15. The apparatus according to claim 10, further comprising storing the URL at the audio-visual device as a bookmark for future use in the case where the user has elected to receive to audio-visual content from an ad hoc source.

16. The apparatus of claim 10, further comprising determining from a server response to the request whether the server response includes one of: user content, seeding metadata for a single content stream, seeding metadata for multiple content streams, seeding metadata including a URL indicating where electronic program guide information may be retreived.

17. The apparatus according to claim 16, wherein if the server response includes seeding metadata for said single content stream, prompting the user to enter a channel number to be associated with the single content stream at the audio-visual device.

18. The apparatus according to claim 16, wherein if the server response includes seeding metadata for multiple content streams:
prompting the user to enter a starting base channel number, and
associating the multiple content streams with the channel numbers starting with the user entered starting base channel number.
